(19) United States
(12) Patent Application Publication
(10) Pub. No.: US 2004/0128313 A1
(43) Pub. Date: Jul. 1, 2004

(54) Database system for outdoor property management and maintenance

(76) Inventor: Wynne J. Whyman, Colorado Springs, CO (US)

Correspondence Address: Thomas S. Birney, Esq., Dorr, Carson, Sloan, Birney & Kramer, P.C., 3010 East 6th Avenue, Denver, CO, 80206, US

(21) Appl. No.: 10/735,416

(22) Filed: Dec. 12, 2003

Related U.S. Application Data
(60) Provisional application No. 60/433,346, filed on Dec. 13, 2002.

(51) Int. Cl. G06F 17/00

(52) U.S. Cl. 707/103 R

(57) ABSTRACT

A database system for managing and maintaining outdoor properties may include property and utility entities, inventory, maintenance, construction, regulatory, staff, management planning, historical, and environmental management data. Users may query the database to retrieve inputted data to access historical records, summarize information, and make future projections.

### RELATED APPLICATION

The present application is based on, and claims priority to the Applicant's U.S. Provisional Patent Application Ser. No. 60/433,346, entitled “Database System For Outdoor Property Management And Maintenance,” filed on Dec. 13, 2002.

### BACKGROUND OF THE INVENTION

1. Field of the Invention

The present invention relates generally to the field of property management systems. More specifically, the present invention discloses a database system for managing and maintaining outdoor properties, such as camps, parks, conference centers, retreat centers, environmental areas, recreational facilities, dude ranches, and the like.

2. Statement of the Problem

Existing systems for managing and maintaining outdoor properties have focused only on specific facets of such properties, such as animal management, camper or room reservations, and utility readings. Currently, information is typically stored in a multitude of locations and formats, such as spreadsheets, word processing documents, file cabinets, index cards, three-ring binders, schedules on drawings, and people's memories. Therefore, a need exists for a comprehensive database system to keep track of all relevant information for an outdoor property.

3. Solution to the Problem

The present invention provides a comprehensive database system that combines maintenance, inventory, personnel, livestock, facility management, and land-based management features in a single integrated package. The present system also logs utility readings and computes monthly usage of well water. Images of buildings and other improvements can be stored. The system can also be linked to a Geographic Information System (GIS) by having a unique GIS number in both the GIS and this system. The user can then click on a feature in the GIS, and display descriptive data and maintenance information from this database system.

### SUMMARY OF THE INVENTION

This invention provides a database for managing and maintaining outdoor properties that may include property and utility entities, inventory, maintenance, construction, regulatory, staff, management planning, historical, and environmental management data. Users may query the database to retrieve inputted data to access historical records, summarize information, and make future projections.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a diagram showing the overall relationship of the tables in the present database.

FIG. 2 is a diagram showing the table structure and relationships for property information.

FIG. 3 is a diagram showing the table structure and relationships for species inventory information.

FIG. 4 is a diagram showing the table structure and relationships for information related to sites and overall entities.

FIG. 5 is a diagram showing the table structure and relationships for information relating to land entities.

FIG. 6 is a diagram showing the table structure and relationships for information relating to utility entities.

FIG. 7 is a diagram showing the table structure and relationships for animal inventory information.

FIG. 8 is a diagram showing the table structure and relationships for equipment inventory information.

FIG. 9 is a diagram showing the table structure and relationships for tool inventory information.

FIG. 10 is a diagram showing the table structure and relationships for vehicle inventory information.

FIG. 11 is a diagram showing the table structure and relationships for staff information.

FIG. 12 is a an example of the reports menu that can be used to generate reports by retrieving data from the present database.

### DETAILED DESCRIPTION OF THE INVENTION

Overview. The present invention is a relational database system for storing and retrieving information relating to an outdoor property. The property contains an arbitrary number of geographic “sites” (sometimes called areas or units) defined by the user. The present system allows sites to the categorized by type. By default, the following site categories are provided, although these can be customized by the user:

1. Geographic areas (e.g., wetland area, species observation area, erosion concerns, meadow)

2. Living units (e.g. campground, counselors' quarters, Maple Leaf living area)

3. Maintenance areas

4. Program areas (e.g., hiking trails, equestrian area, amphitheater)

In turn, each site holds an arbitrary number of “entities” defined by the user. Each entity can be viewed as a separate item fixed to the property, such as fences, waterlines, buildings, swimming pools, leach fields, etc. Each entity can be categorized by type, such as cabin, electrical pole, parking lot, lodge, or latrine. A default list of entity categories is built into the present system, but these categories can be customized by the user.

In addition, the present system includes tables for inventory information on equipment, tools, staff, animals, vehicles, and observed species associated with the property. Optionally, the present system can monitor electric meter readings, insurance, inspections, propane tank fillings, water quality testing, well water consumption, and store other environmental management information.

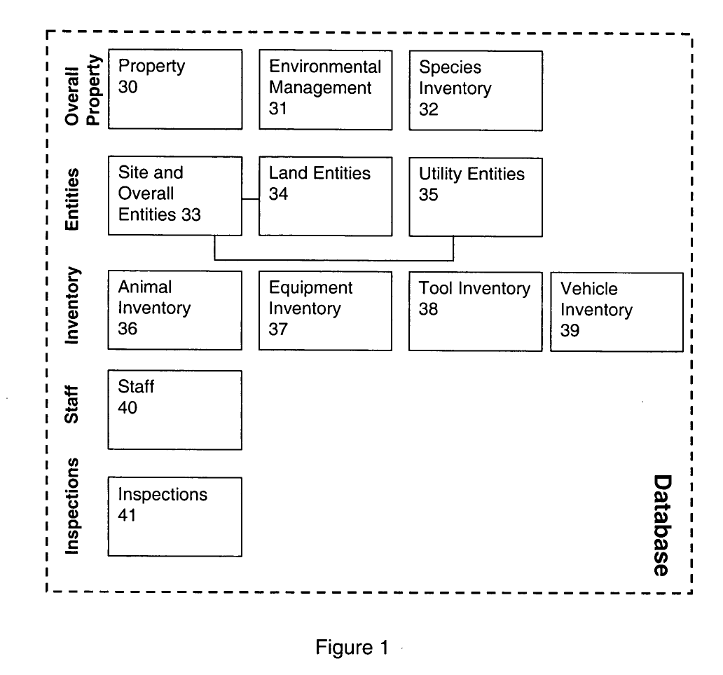

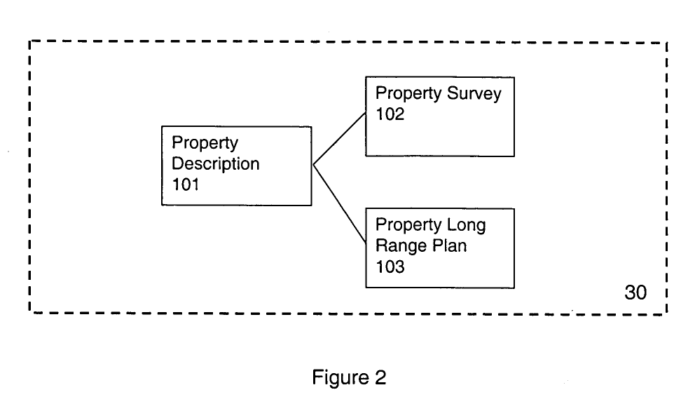

Database Structure. FIG. 1 is a diagram showing the overall structure of the present database, and in particular, the relationship between the tables illustrated in FIGS. 2 through 6. This database is a collection of several tables to give an outdoor property manager the tools that he or she needs. However, each property may or may not have a particular component for their operation. Furthermore, even though a property may have a particular component, the user may decide not to keep record information about it. Thus, the database can be used in part or in its entirety, since data is optional and customizable to meet the user's needs. If the user decides to use a particular component, there are minimal required fields to make the database structure work and to define the bare minimum of each record in a table. The user can decide whether to record information in a particular table or a particular field.

FIG. 2 is a diagram showing the table structure and relationships for property-related information 30. The user can choose to record information about different aspects about the property itself, using data from both internal and external sources. The fields store information from legal documents (e.g., deeds, water rights), maps, constraints and categorization from regulatory agencies, water well drilling projects, surveys, planning, and other documents that pertain to the property itself. This allows quick access to pertinent information that is usually stored in many physical locations, accessing information for architectural planning, etc.

In particular, the property description table 101 in FIG. 2 stores information about the overall property. Related to each property, there can be many surveying projects 102. Also related to each property, there can be many long-range plans 103. Fields can be summarized as land, easements/leases, environmental, historical, mineral rights, ownership, regulatory, new building construction, site planning, and water. Fields include property name, legal description, leased, lease description, owned, deed location, mortgaged, mortgage description, adjacent properties description, purchase date, purchase cost, previous owners, history, historical description, previous locations, number of acres, USGS map, tax status, easements, subleases, nearby government lands, permits required, water identification number, water district, water rights, mineral rights, gas rights, environmental protection, comments, previous property names, county, building code, planning authority, planning authority regulations, zoning classification, use classification, conforming use, non-conforming special use permit, land use description, water supply capacity, water supply source, sanitation district, and waste water restrictions. Key information is the legal description, leasing/purchase information, and water/mineral rights.

The property survey table 102 in FIG. 2 contains information about any type of surveying project such as professional surveying, aerial photography, GPS readings, and other user-defined categories. Fields include date, site name (referencing one field in the master site table 107), type of survey, work done by, report received, brief summary, cost, fund source, next service date, and comments. Key information is date, next service date, and type of survey.

The property long range plan table 103 in FIG. 2 contains information about any type of long range plans done by volunteer committees or paid consultants, such as master plans, strategic plans, and other user-defined categories. Fields include date, type of plan, work done by, whether the report was received, brief summary, cost, fund source, next service date, and comments. Key information is date, next service date, and type of plan.

As shown in FIG. 1, the user can choose to record information about any studies or events that relate or impact the soil, land, or vegetation in the environmental management table 31. The study may include forest management, soil testing, geology studies, erosion control studies, hydrologist analyst, flood plain analysis, controlled burns, and other user-defined categories. This allows the user to see the results of a study, without reading the entire document; know when a study was last conducted, who did the work, etc. Fields include year, environmental management type, site name (referencing one field in master site table 107), description, cost, fund source, work one by, architect, plans, plans location, next service date, and comments. Key information is year, next service date, and description.

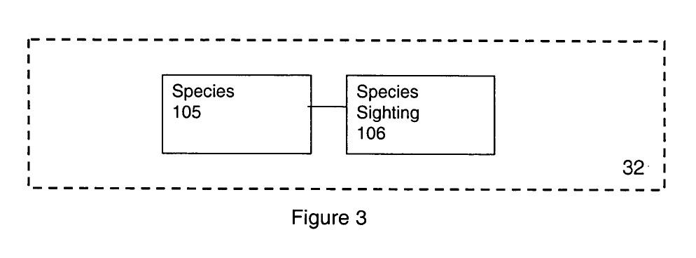

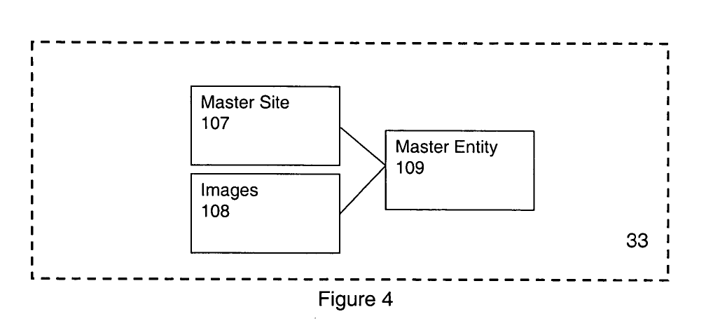

FIG. 3 is a diagram showing the table structure and relationships for species inventory information 32. The user can choose to record information about the birds, animals, flowers, plants, trees, etc. that are found on the property. A related table captures the information about viewing or inventorying the species. This information may be used for educational purposes for clients, site planning, long-range impact studies, etc. The fields in the species table 105 shown in FIG. 4 include common name, Latin name, image full pathname, and comments. Key information is the name (either common or Latin).

Related to each record in the species table, there can be many sightings stored in the species sighting table 106. The fields in the species sighting table 106 include date, site name (referencing one field in master site table 107), specific area description, quantity seen, next service date, and comments. Key information is the date and area seen.

FIG. 4 is a diagram showing the table structure and relationships for site and overall entities information 33. The user can choose to record information about entities in a user-defined, geographical location. In FIG. 4, these tables divide the property geographically and then associate entities with a geographic location. An outdoor property can be divided into geographic groups, areas, units, or sites. These sites may be divided by property maintenance, activity-based, housing, land-focused, historical, geographical, or environmental, or other user-defined categories. An entity is something fixed or part of the property, which can be below, on or above the land. Examples are fences, swimming pool, trail, leach field, surface mining pit, etc. In comparison, inventory items (e.g., llamas, kitchen mixer) are not entities. This information may be used for locating utility lines, analyzing funding sources, construction information, etc.

The master site table 107 shown in FIG. 4 includes fields for the site name, site description, site category, location, year, date dedicated, total cost, fund source, description of how it was built, contractor, architect, plans, plans location, history of the site name, history description, status, an indicator of whether there images, and comments. Related to each master site, there can be many records in the master entities table 109. Key information is the name, year built, and construction data.

The images table 108 shown in FIG. 4 stores any digital images linked to the database. Digital images may include construction progression, blueprints, drawings/sketches, newspaper clippings, maps, scanned memorabilia, invitations, diagrams, land plats, aerial photographs, deeds, contracts, historical images, historical documents, historical activities, and other user-defined needs. Fields include site, year, full pathname, description, date digitized, original source, and comments. Key information is the name/path name.

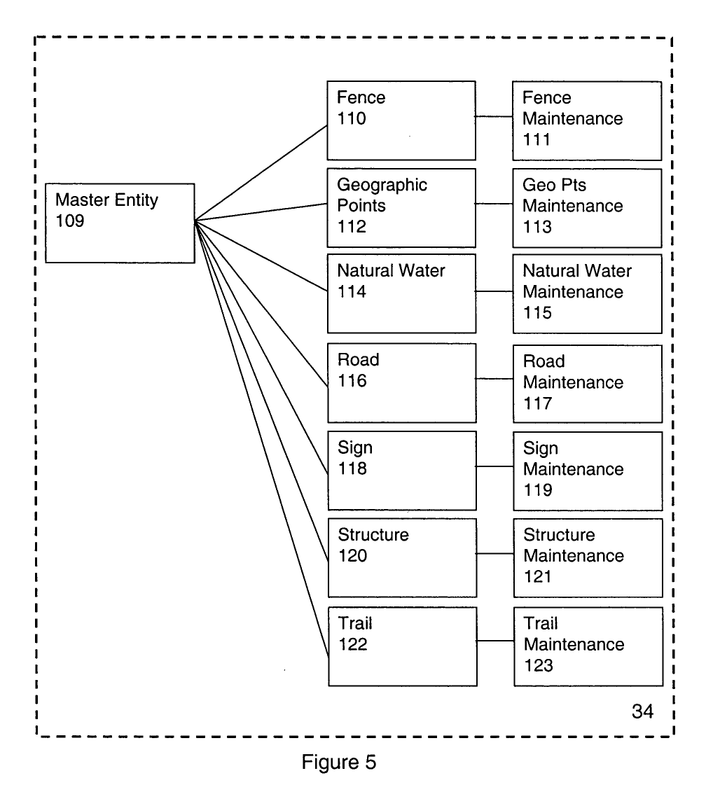

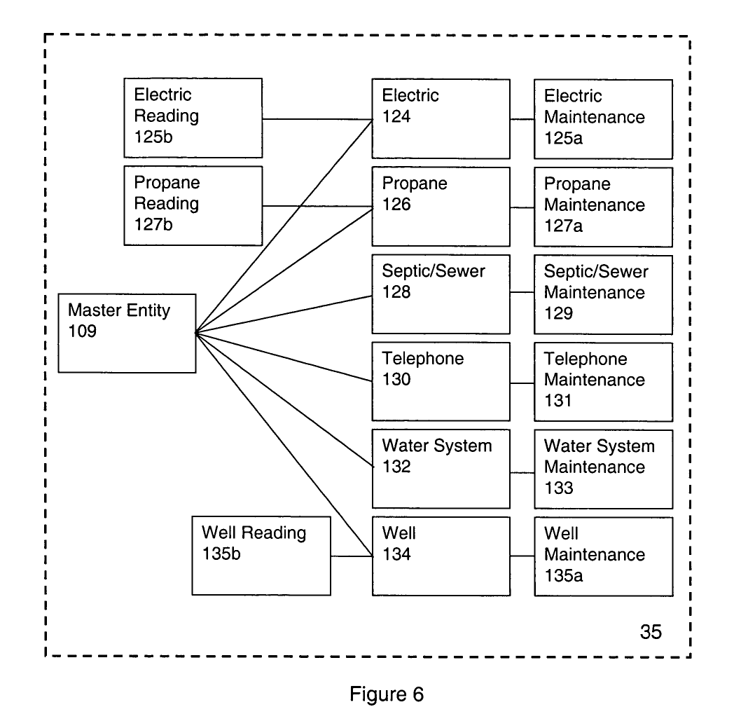

The master entity table 109 shown in FIGS. 4, 5, and 6 contains fields that are common to all entities. Fields include classification, site name (referencing one field in the master site table 107), entity name, entity description, year built, replacement year, original cost, fund source, work done by, architect, CAD information, plans, plans location, warranty, status, and comments. In addition, there are two fields that can be used to tie into a Geographic Information System (GIS). The first is the GIS field which stores a unique GIS number that can be linked to a Geographic Information System (GIS). For example, a person can click on a waterline in a GIS, get the number, and then query the present database to find the entity and its related data. Second, the master entity table 109 contains a field with a shape table description on where the entity can be found in the GIS system. For each record in the master entity table, there can be many images 108 and many specific entities in tables 110, 112, 114, 116, 118, 120, 122, 124, 126, 128, 130, 132, and 134, shown in FIGS. 5 and 6. Key information is the entity name, year built, replacement year, and construction information.

FIG. 5 is a diagram showing the table structure and relationships for land entities information 34. In the preferred embodiment of the present invention, there are 13 different types of entities, which are an extension of the master entity table 109, shown in both FIGS. 4, 5 and 6. These 13 entities give the specific details about a particular entity and the related maintenance on each entity. Furthermore, the 13 entities are grouped into two categories, land (FIG. 5) and utilities (FIG. 6). FIG. 5 shows seven sets of tables that are land-based. This information may be used to determine replacement schedules, insurance schedules, planned maintenance projects, aid in long-range planning for capital campaigns, etc.

The fence table 110 referenced in FIG. 5 contains fields in addition to those provided in the master entity table 109 to specifically describe each fence. These fields include linear length of fence, and type of fence (such as barbed wire, wooden, and other user-defined categories). Related to each record in the fence table, there can be many records in the fence maintenance table 111. Key information is the linear length of the fence.

The fence maintenance table 111 shown in FIG. 5 contains maintenance records for each fence. Fields include date, status, maintenance type, next service date, description, cost, fund source, work done by, warranty, actual hours, and comments. Key information is the date, next service date, and description.

The geographic points table 112 in FIG. 5 contains fields in addition to those provided in the master entity table 109 to specifically describe each geographic point. Examples are clay deposits, erosion berms, abandoned mines, etc. Fields include size. Related to each record in the geographic point table, there can be many records in the geographic points maintenance table 113. Key information is size.

The geographic points maintenance table 113 in FIG. 5 contains maintenance records on the geographic points. Fields include date, status, maintenance type, next service date, description, cost, fund source, work done by, warranty, actual hours, and comments. Key information is the date, next service date, and description.

The natural water table 114 in FIG. 5 contains fields in addition to those provided in the master entity table 109 to specifically describe the natural water entities, such as ponds, lakes, creeks, rivers, shorelines, etc. Fields include maximum depth. Related to each record in the natural water table 114, there can be many records in the natural water maintenance table 115. Key information is the depth.

The natural water maintenance table 115 in FIG. 5 contains maintenance records for the natural water entities. Fields include date, status, maintenance type, next service date, description, cost, fund source, work done by, warranty, actual hours, and comments. Key information is the date, next service date, and description.

The road table 116 in FIG. 5 contains fields in addition to those provided in the master entity table 109 to specifically describe the roads. Examples are 4WD, primary, secondary, etc. Related to each record in the road table 116, there can be many records in the road maintenance table 117. Fields include road length, road width. Key information is road length.

The road maintenance table 117 in FIG. 5 contains records on road maintenance. Fields include date, status, maintenance type, next service date, description, cost, fund source, work done by, warranty, actual hours, and comments. Key information is the date, next service date, and description.

The sign table 118 in FIG. 5 contains fields in addition to those in the master entity table 109 to specifically describe each sign. Examples are entrance signs, speed limit, destination, etc. Fields include sign wording and sign materials. Related to each record in the sign table 118, there can be many records in the sign maintenance table 119. Key information is sign wording.

The sign maintenance table 119 in FIG. 5 contains information on sign maintenance. Fields include date, status, maintenance type, next service date, description, cost, fund source, work done by, warranty, actual hours, and comments. Key information is the date, next service date, and description.

The structure table 120 in FIG. 5 contains fields in addition to those in the master entity table 109 to specifically describe structures, such as buildings, outbuildings, riding arena, cement pads for trash dumpsters, etc. Fields include dimensions, square feet, capacity, ADA accessible, historical, amenity water, amenity electricity, amenity telephone, amenity gas, amenity wood burning stove, amenity insulation, amenity other, insure, floor construction material, roof construction material, wall construction material, number of stories, distance from fire hydrant, sprinklers, appraise value, appraise date, replacement cost square foot, replacement cost value, contents, date last updated insurance, insurance comments, certificate of occupancy. Related to each record in the structure table 120, there can be many records in the structure maintenance table 121. Key information is dimensions, and basic insurance information.

The structure maintenance table 121 in FIG. 5 contains maintenance records for each structure. Fields include date, status, maintenance type, next service date, description, cost, fund source, work done by, warranty, actual hours, and comments. Key information is the date, next service date, and description.

The trail table 122 in FIG. 5 contains fields in addition to those in the master entity table 109 to specifically describe each trail. Fields include horse, pedestrian, ADA accessible. Related to each record in the trail table 122, there can be many records in the trail maintenance table 123. Key information is description(s) of trail.

The trail maintenance table 123 in FIG. 5 contains maintenance records for each trail. Fields include date, status, maintenance type, next service date, description, cost, fund source, work done by, warranty, actual hours, and comments. Key information is the date, next service date, and description.

FIG. 6 is a diagram showing the table structure and relationships for utility entities information 35. There are six sets of tables that relate to utilities, which completes the 13 different types of entities described in FIG. 4. This information may be used to keeping a supply of the right-sized materials on-hand, replacement schedules, planned maintenance projects, summarizing work performed, etc.

The electric table 124 in FIG. 6 contains fields in addition to those provided in the master entity table 109 to specifically describe the electric entities, such as meters, lines, etc. Fields include size/length. Related to each record in the electric table 124, there can be many records in the electric maintenance table 125a. Key information is size/length.

The electric maintenance table 125a in FIG. 6 contains maintenance records for electric entities. Fields include date, status, maintenance type, next service date, description, cost, fund source, work done by, warranty, actual hours, and comments. Key information is the date, next service date, and description.

The electric reading table 125b in FIG. 6 contains information from electric meter readings. Fields include date, reading, KWH used, total cost, and comments. Key information is date, reading.

The propane table 126 in FIG. 6 contains fields in addition to those provided in the master entity table 109 relating to propane entities, such as propane tanks, lines, etc. Fields include size/length. Related to each record in the propane table 126, there can be many records in the propane maintenance table 127a. Key information is size/length.

The propane maintenance table 127a in FIG. 6 logs maintenance of propane entities. Fields include date, status, maintenance type, next service date, description, cost, fund source, work done by, warranty, actual hours, and comments. Key information is the date, next service date, and description.

The propane reading table 127b in FIG. 6 logs information about when the propane tanks are refilled. Fields include date, gallons, total cost, and comments. Key information is date, gallons.

The septic/sewer table 128 in FIG. 6 contains fields in addition to those provided in the master entity table 109 to specifically describe each septic/sewer entity, such as leech fields, septic tanks, waste lines, etc. Fields include size/length. Related to each record in the septic/sewer table 128, there can be many records in the septic/sewer maintenance table 129. Key information is size/length.

The septic/sewer maintenance table 129 in FIG. 6 logs maintenance on the septic/sewer entities. Fields include date, status, maintenance type, next service date, description, cost, fund source, work done by, warranty, actual hours, and comments. Key information is the date, next service date, and description.

The telephone table 130 in FIG. 6 contains fields in addition to those provided in the master entity table 109 to specifically describe each telephone entity, such as pedestals, lines, etc. Fields include size/length. Related to each record in the telephone table 130, there can be many records in the telephone maintenance table 131. Key information is size/length.

The telephone maintenance table 131 in FIG. 6 logs maintenance on the telephone entities. Fields include date, status, maintenance type, next service date, description, cost, fund source, work done by, warranty, actual hours, and comments. Key information is the date, next service date, and description.

The water system table 132 in FIG. 6 contains fields in addition to those provided in the master entity table 109 to specifically describe each water system entity, such as storage tanks, spigots, shut-off valves, connectors, etc. Fields include waterline size, waterline type, waterline depth, waterline summer/winter. Related to each record in the water system table, there can be many records in the water system maintenance table 133. Key information is waterline size, type, and material.

The water system maintenance table 133 in FIG. 6 logs maintenance on each water system entity. Fields include date, status, maintenance type, next service date, description, cost, fund source, work done by, warranty, actual hours, and comments. Key information is the date, next service date, and description.

The well table 134 in FIG. 6 contains fields in addition to those in the master entity table 109 to specifically describe each well. Examples include drinking water wells, test hole, monitoring well, etc. Fields include well gallons per minute (gpm), well depth, description of casing, pump depth, pump manufacturer, pump purchase date, pump cost, pump serial number, pump comments, pump bought from, pump warranty, pump next replacement date, and comments. Related to each record in the ell table, there can be many records in the well maintenance table 135a. Key information is depth, description of casing, pump depth, basic pump information.

The well maintenance table 135a in FIG. 6 contains maintenance records on the wells. Fields include date, status, maintenance type, next service date, description, cost, fund source, work done by, warranty, actual hours, and comments. Key information is the date, next service date, and description.

Some wells have a meter attached to record the number of gallons of well water pumped. The well reading table 135b holds these meter readings. Fields include date, reading, psi, and comments. Key information is date and reading.

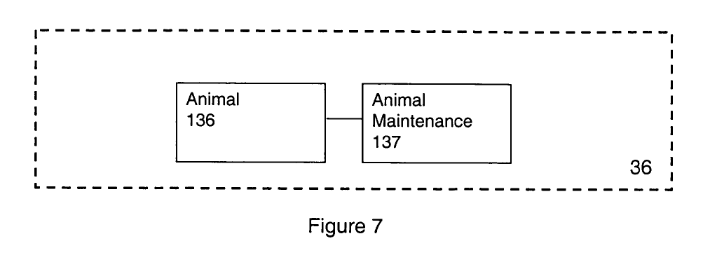

FIG. 7 is a diagram showing the table structure and relationships for animal inventory information 36. The user can choose to record information about animals and any associated maintenance/servicing for the animal. Animals may include horses, llamas, donkeys, goats, mules, sheep, and other user-defined categories. This information may be used to train seasonal staff, insurance schedules, planned service (calling a farrier), etc.

The animal table 136 in FIG. 7 contains information about each animal. Fields include animal type, status, last date updated, name, animal breed, animal color, markings, gender, date born, date acquired, next replacement date, donated/purchased, purchase price, fund source, acquisition comments, brand inspector, brand inspector name, brand inspector date, description of brand, registered, registration number, registration organization, registration comments, insured, market value, market date, full pathname for digital picture, full pathname for markings digital picture, tack to be used, special diet, temperament, how trained, rider level, type of rider, restrictions, and overall comments. Related to each record in the animal table, there can be many records in the animal maintenance table 137. Key information is date born, replacement date, animal breed, differentiating description—color/markings/brand, and insurance information.

The animal maintenance table 137 in FIG. 7 lists any service on an animal, such as shoeing, vet, trimming, etc. Fields include date, status, next service date, service description, cost, fund source, work done by, actual hours, and comments. Key information is the date, next service date, and description.

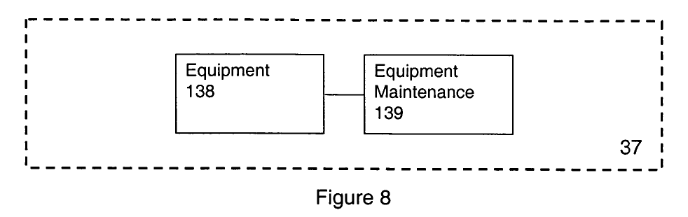

FIG. 8 is diagram showing the table structure and relationships for equipment inventory information 37. The user can choose to record information and their associated maintenance on the equipment. Equipment may include boats, computers, household appliances (e.g., washers, dryers), commercial kitchen equipment (e.g., stoves, dishwashers), office (e.g., copiers, faxes), physical plant (e.g., furnaces, boilers, generators), water system (e.g., pumps, chlorinators, pressure tanks), and other user-defined categories. This information may be used for replacement schedules, insurance schedules, planned maintenance, knowledge about the equipment.

The equipment table 138 in FIG. 8 lists equipment entities and includes fields for equipment category, description, date purchased, company, warranty, replacement date, serial number, model number, brand, cost, fund source, new/used, condition, full pathname for digital image, status, insure, replacement cost, date last insurance updated, insurance comments, and general comments. Related to each record in the equipment table, there can be many records in the equipment maintenance table 139. Key information is date, replacement date, description, and insurance information.

The equipment maintenance table 139 in FIG. 8 lists any service to the equipment. Fields include date, status, maintenance type, next service date, description, cost, fund source, work done by, warranty, actual hours, and comments. Key information is the date, next service date, and description.

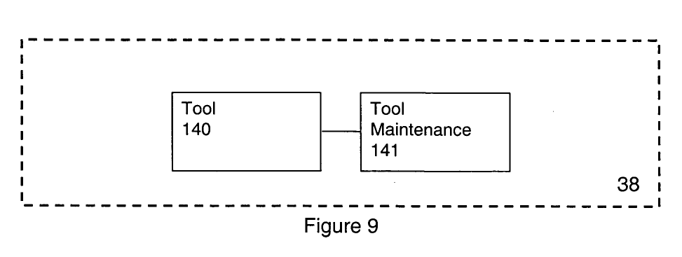

FIG. 9 is a diagram showing the table structure and relationships for tool inventory information 38. The user can choose to record information and their associated maintenance on the tools. Tools may include machine, power tools, camping tools (e.g., axes, bow saws), hand tools, and other user-defined categories. This information maybe used by auditors, insurance schedules, inventory needs, etc.

The tool table 140 in FIG. 9 lists any type of tool. Fields include description, category, date purchased, company, warranty, serial number, model number, brand, cost, new/used, condition, toolbox, actual, full pathname for digital image, status, next replacement date, fund source, insure, tool quantity, replacement cost each, total replacement cost, last date insurance updated, insurance comments, and overall comments. Related to each record in the tool table, there can be many records in the tool maintenance table 141. Key information is date, replacement date, description.

The tool maintenance table 141 in FIG. 9 lists service to each tool. Fields include date, status, maintenance type, next service date, description, cost, fund source, work done by, warranty, actual hours, and comments. Key information is the date, next service date, and description.

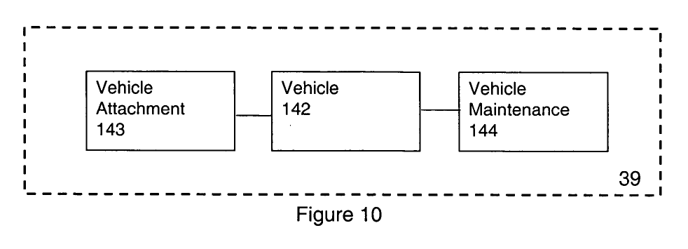

FIG. 10 is a diagram showing the table structure and relationships for vehicle inventory information 39. The user can choose to record information, their associated vehicle attachments, and their associated maintenance on the vehicles. A vehicle is defined as any type of vehicle or trailer, with or without a motor, such as tractors, trailers, trucks, mules, golf carts, and other user-defined categories. A vehicle attachment is any attachment to the vehicle, such as snowplows, mowers, and other user-defined categories. This information may be used for planned maintenance, replacement schedules, insurance schedules, inventory needs, etc.

The vehicle table 142 in FIG. 10 contains fields that include vehicle type, description, year, make, model, VIN number, date purchased, next replacement date, fund source, cost, purchased from license number, license renewal month, county licensed, full pathname of digital image, status, insure, replacement cost, last date insurance updated, insurance comments, and overall comments. Related to each record in the vehicle table, there can be many records in the vehicle maintenance table 144 and many records in the vehicle attachments table 143. Key information is year, replacement date, description.

The vehicle attachment table 143 in FIG. 10 contains fields including description, year, company purchased, cost, fund source, serial number, and comments. Key information is year, description.

The vehicle maintenance table 144 in FIG. 10 lists any service to each vehicle. Fields include date, status, maintenance type, next service date, description, cost, fund source, work done by, warranty, actual hours, and comments. Key information is the date, next service date, and description.

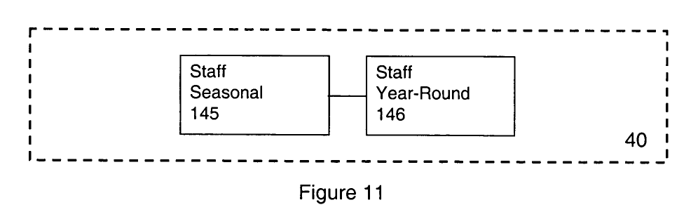

FIG. 11 is a diagram showing the table structure and relationships for staff information 40. The user can choose to record information about the staff, both seasonal and year-round. For example, this information may be used to cross-reference construction notes, or keep an alumni name listing for possible fund development solicitation for the property, etc.

The seasonal staff table 145 in FIG. 11 lists seasonal staff (e.g., summer, winter, etc.). Fields include last name, first name, nickname, position, and comments. Key information is last name, first name.

The year-round staff table 146 in FIG. 11 lists year-round, permanent staff. Fields include year, location, site manager, assistant site manager, site director, assistant site director, program director, executive director, president, and comments. Key information is year, site manager, and site director.

As shown in FIG. 1, the database can also include a table for Environmental Management information 31. The user can choose to record information about environmental management. This table is used to log any visits and studies, and may include the forest service, EPA, soil studies, conservation organizations, foresters, hydrologists, and other user-defined categories. This information may be used for scheduled work, trend analysis, summary reports, etc. Fields include year, location, environmental management category, description, work done by, and comments.

As shown in FIG. 1, the database can also include a table for inspections information 41. The user can choose to record information about inspections. This table is used to log any inspections for the property, activities, or visits. Inspections may include fire department, hydrant flow, sprinklers, state licensing, accreditation, health inspection, and other user-defined categories. This information may be used for scheduled work, trend analysis, summary reports, etc. Fields include date, inspection type, name, inspector name, next inspection date, contact name, report received, and comments. Key information is date, next service date, inspection type, and results.

Optionally, a number of other tables can be included in the present database beyond those shown in FIG. 1. For example, the user can choose to record information about water quality testing results. Testing may include bacteria, nitrate, nitrite, and other user-defined categories. This information may be used for planned maintenance, work performed, cross-referenced documentation, trend analysis, etc. Fields in this table can include date, location, testing organization, testing type, level, next testing date, report received, and comments.

If desired, a separate table can be provided to record information about the chlorine levels in drinking water. This test is generally done by on-site staff to regulate the chlorinator. This information may be used for planned maintenance, documentation, trend analysis, etc. Fields include date, location, chlorine level, next test date, and comments.

The user can also choose to record information as a tool for budget time and money towards the new projects for the year. This would not typically include repeating projects (if they are repeating projects, they would go under the annual maintenance schedule), or planned maintenance (these are already in the system as entity and inventory maintenance items). This information can be used to determine if there are enough resources, budget proposals, etc. Fields include year, month, completed, project name, project description, budget, time estimate-days, and comments.

The user can choose to record information about the projects/tasks that need to be done periodically on a regular basis. Examples include fire extinguisher testing, water pressure testing, fire inspection, rope course inspection, horses shod, vet visits, fire sprinkler testing. This may be used to record tasks that are regularly done to serve as a “tickler file” (e.g., inspections that occur on a regular basis). Fields include month, description, predecessor, completed, and comments.

The present database can be implemented using Microsoft Access. This makes it easy for users to customize the database to meet their specific needs (e.g., adding or deleting fields, customizing reports, or making fields mandatory or optional). Entire tables can be readily added or eliminated depending on the user's particular region and property type. However, other relational database software using structured query language (SQL), such as Oracle, FileMakerPro, etc., could be readily substituted. The system can be designed to run on a stand-alone computer or on a local network or the internet.

It should be expressly understood that although the preceding discussion has focused on one possible implementation of the present invention, other embodiments are possible. For example, several of the tables could be combined. One master list could contain all of the entities. Information that is currently stored in the fences table 110 and structures table 120, etc. could be all combined and stored in the master entity 109. Extra fields would then be added to describe each entity. Because all entities do not need all these additional field descriptions, it would create a poorer database design because there would be wasted space in the database. Similarly, tables could be split into smaller tables or may contain fewer fields. Several of the fields in a table could be combined in a single field as free form text (e.g., “surveys done” or “long range planning”). Finally, there is a lot of discretion in providing look-up tables for fields in the various tables. Look-up tables help to simplify data input and maintain data consistency.

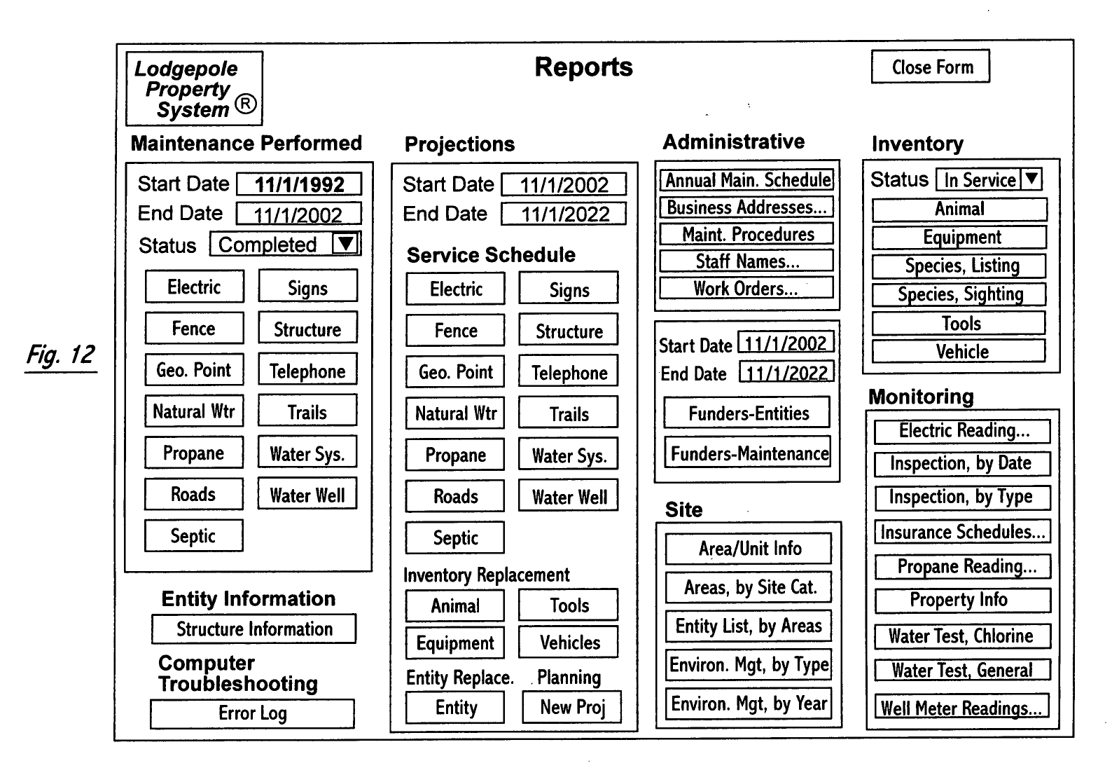

FIG. 12 is an example of the reports menu in the present system showing the various types of reports that can be generated using the tables described above. Data can also be extracted via SQL queries or any of the other tools available in Microsoft Access. Also using the Microsoft Office capabilities, data can be exported into Microsoft Word or Microsoft Excel.

The above disclosure sets forth a number of embodiments of the present invention. Other arrangements or embodiments, not precisely set forth, could be practiced under the teachings of the present invention and as set forth in the following claims.

I claim:

1. A database system for storing and retrieving data for managing an outdoor property, said database system comprising:
at least one property description table containing data relating to an outdoor property;
at least one site table containing data relating to a plurality of sites within the property; and
at least one entity table containing data relating to entities within sites in the site table.

2. The database system of claim 1 further comprising an inventory table containing data relating to inventories of items associated with the property.

3. The database system of claim 2 further comprising an inventory maintenance table containing data relating to maintenance of inventory items.

4. The database system of claim 1 further comprising a property survey table containing data relating to surveys of the property.

5. The database system of claim 1 further comprising a property long-range plan table containing data relating to long-range plans for the property.

6. The database system of claim 1 further comprising a staff table containing data relating to staff members assigned to the property.

7. The database system of claim 1 further comprising an inspections table containing data relating to inspections of the property.

8. The database system of claim 1 wherein the sites in the site table comprise geographic areas.

9. The database system of claim 1 wherein the sites in the site table comprise living units.

10. The database system of claim 1 wherein the sites in the site table comprise maintenance areas.

11. The database system of claim 1 wherein the sites in the site table comprise program areas.

12. The database system of claim 1 wherein the entities in the entity table are selected from the group comprising structures, fences, waterlines, swimming pools, leach fields, electrical poles, parking lots, and latrines.

13. The database system of claim 1 further comprising at least one maintenance table containing data relating to maintenance for entities in the entity table.

14. The database system of claim 1 further comprising an environmental management table containing data relating to environmental management of the property.

15. A database system for storing and retrieving data for managing an outdoor property, said database system comprising:
at least one property description table containing data relating to the physical description of an outdoor property;
at least one entity table containing data relating to a plurality of entities within the property; and
at least one maintenance table containing data relating to maintenance of entities in the entity table.

16. The database system of claim 15 further comprising a site table containing data relating to a plurality of sites within the property, and wherein each entity is associated with one of the sites in the site table.

17. The database system of claim 15 further comprising an inventory table containing data relating to inventories of items associated with the property.

18. The database system of claim 17 further comprising an inventory maintenance table containing data relating to maintenance of inventory items.

19. The database system of claim 15 further comprising a property survey table containing data relating to surveys of the property.

20. The database system of claim 15 further comprising a property long-range plan table containing data relating to long-range plans for the property.

21. The database system of claim 15 further comprising a staff table containing data relating to staff members assigned to the property.

22. The database system of claim 15 further comprising an inspections table containing data relating to inspections of the property.

23. The database system of claim 15 wherein the entities in the entity table are selected from the group comprising structures, fences, waterlines, swimming pools, leach fields, electrical poles, parking lots, and latrines.

24. The database system of claim 15 further comprising an environmental management table containing data relating to environmental management of the property.
